(19) United States
(12) Patent Application Publication
(10) Pub. No.: US 2015/0265384 A1
(43) Pub. Date: Sep. 24, 2015

(54) DISCRETE FLUID BURST ORAL CLEANING APPLIANCE

(71) Applicant: KONINKLIJKE PHILIPS N.V., Eindhoven (NL)

(72) Inventors: Koji Intlekofer, Seattle, WA (US); Bethany Joyce Johnson, Snoqualmie, WA (US)

(73) Assignee: Koninklijke Philips N.V., Eindhoven (NL)

(21) Appl. No.: 14/440,894

(22) PCT Filed: Nov. 27, 2013
(86) PCT No.: PCT/IB2013/060450

§ 371 Date: May 6, 2015

Related U.S. Application Data
(60) Provisional application No. 61/732,561, filed on Dec. 3, 2012.

(51) Int. Cl. A61C 17/028; A61C 17/32; A61C 17/02

(52) U.S. Cl. CPC A61C 17/028; A61C 17/0202; A61C 17/32

(57) ABSTRACT

The appliance includes a body (12) which includes a tank (22) for liquid. A pump/regulator assembly (18, 20) maintains pressure in the tank in the range of 70-120 psi. A valve, timer and controller (30, 31, 37) controls sequential bursts of liquid, with each burst having a duration of 0.02-2 seconds, with the total amount of liquid in a single cleansing event being less approximately 0.2 ml or less. A firing rate is such that successive bursts of liquid are separated by a controlled time when there is no liquid delivery.

### TECHNICAL FIELD

This invention relates generally to oral hygiene appliances, and more specifically to such appliances using a stream or jet of liquid for cleaning teeth.

### BACKGROUND OF THE INVENTION

Removal of biofilm and improvement of gum tissue health through the use of a fluid stream or jet is well established. Some appliances use a continuous or pulsed jet of liquid, which is initiated and stopped by user action, although in some cases the action is automatically stopped after a predetermined amount of time, e.g. two minutes. While the plaque removal and gum tissue health benefits have been demonstrated, continuous or pulsed fluid jets can be messy and can even cause discomfort to the user under some conditions because of the amount (the volume of fluid, usually water) used in the device during a typical cleaning event. Typically, such appliances for a typical two-minute treatment time use well over 0.2 ml of liquid.

Accordingly, it is desirable to develop an effective oral cleaning appliance which uses liquid for cleaning, but limits the volume of fluid per cleaning event to a comfortable amount for the user.

### SUMMARY OF THE INVENTION

Accordingly, the oral care appliance comprises; an appliance body; a liquid reservoir containing at least one cleansing amount of liquid; a pump/regulator combination for maintaining pressure in the reservoir in the range of 70-120 psi; and a control assembly for providing successive bursts of liquid, each burst having a duration of 0.02-2 seconds, wherein the total amount of liquid in a single cleansing event is approximately 0.2 ml or less.

### BRIEF DESCRIPTION OF THE DRAWINGS

FIG. 1 is a cross-sectional diagram of the fluid appliance described herein.

FIG. 2 is a cross-sectional diagram of the fluid appliance using a bristle assembly.

### BEST MODE FOR CARRYING OUT THE INVENTION

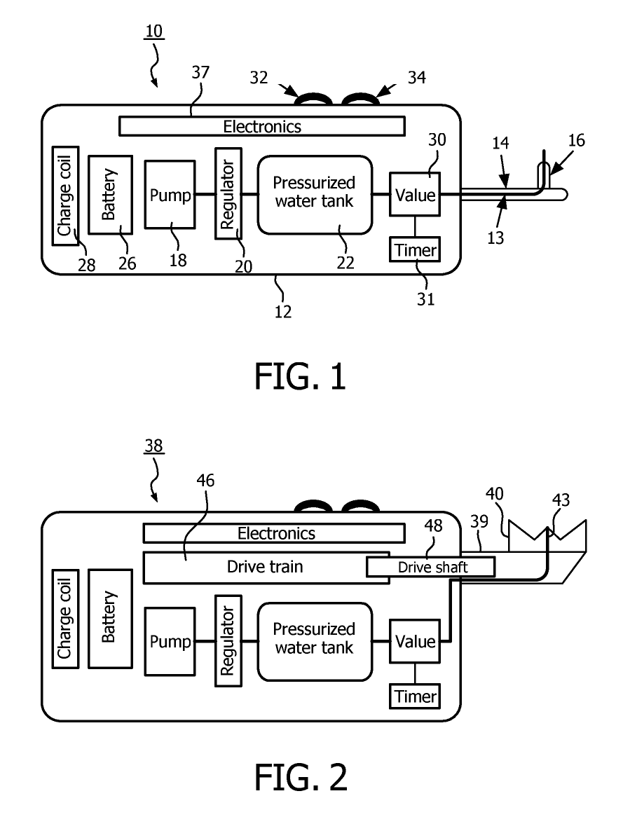

FIG. 1 shows a fluid-based cleaning appliance, generally at 10. Typically the fluid is water, although it could be other liquids, including medications. The appliance 10 includes an appliance body 12, which includes a fluid delivery system for producing discrete bursts of fluid and an outlet for the fluid bursts which proceed through a fluid delivery path 13 in an outlet member 14, at the end of which is a nozzle assembly 16, which could include a single nozzle or a plurality of nozzles. The discrete fluid bursts from nozzle 16 are sufficient to effectively manage biofilm through mechanical removal thereof, with a resulting reduction in the virulence of microorganisms in the mouth. The discrete fluid bursts provide a cleansing benefit greater than toothbrush bristles alone, because the fluid bursts are able to reach between the teeth and along the gum line where bristles cannot reach. The use of discrete i.e. separate bursts of fluid, as opposed to a continuous or pulsed jet of fluid, results in substantially less total liquid volume per brushing event, which enhances user comfort and compliance, while maintaining effectiveness. The cleaning event is typically two minutes.

The delivery system includes a displacement pump 18, which is programmed in combination with a regulator 20, to provide discrete bursts of liquid, typically water, as indicated above from a tank 22. The regulator 20 maintains the pressure in the water tank 22 at a specified level. Typically, the pressure is in the range of 40-120 psi, with a preferred range of 70-112 psi. The water tank holds a cleansing event amount of liquid, slightly less than 0.2 ml. It has been discovered that a user can readily tolerate this amount of liquid in a normal cleansing event of two minutes. The appliance also includes a battery 26 which operates pump 18 and a conventional charger coil 28, which is used with a charging member (not shown). Controlling the release of liquid from the water tank is a valve 30, which is for instance a solenoid valve, and a timer 31. The appliance also includes a power button 32 and a firing button 34, although those two functions can be combined in a single element. A microcontroller 37 controls the operation of the appliance, including an automatic mode of operation for the appliance.

The discrete fluid bursts are predefined in terms of time duration and firing rate. In a manual mode, the bursts are generated by operating firing button 34. Timer 31 controls the duration of the fluid bursts. The burst time duration range is 0.02-2 seconds, with a preferred time duration of 0.05-0.2 seconds. The firing rate in a manual mode is controlled by the user, which is typically significantly longer than the burst duration.

In automatic mode, which is controlled by microcontroller 37, the time duration of the liquid burst will be the same as in the manual mode. The automatic mode may be initiated by a programmed sequence of operating the on-off switch 32 or by a separate switch member/button 34 for the user to operate. The firing rate will be automatically controlled or pre-programmed, typically, 0.1-2 seconds, with a preferred range of firing rate of 0.5-1.5 seconds. In some cases, the time duration of the burst and the firing rate may be adjusted by the user by a predefined sequence of operating the on-off switch. In other cases, the firing rate is permanently set during manufacture.

The advantage of the present system is that the discrete fluid bursts produced by the system of FIG. 1 provides effective cleaning for the teeth and effective treatment of the gum tissue, but with the total volume of liquid being comfortable for the user with a typical cleansing event time of two minutes, which is an encouragement for regular use.

FIG. 2 shows a variation of the embodiment of FIG. 1, with the appliance 38 having a similar fluid delivery arrangement, but with the addition of outlet member 39 being driven in a desired physical movement, such as a back-and-forth oscillatory action, with a set of bristles 40 being positioned at the end of the outlet member. Nozzle 43 will typically be positioned within the set of bristles 40. The appliance 38 will include a drive train assembly 46, with a drive shaft 48 extending therefrom to drive outlet member 39. The drive train assembly 46 could comprise various arrangements, including a motor. The drive train is controlled by microcontroller 37.

Accordingly, an oral care appliance has been shown and described which produces a sequence of discrete, i.e. separate fluid bursts, either by manual operation or automatic operation, which results in a cleansing effect without the mess or discomfort of conventional fluid jet delivery appliances, because of a large volume of fluid in a typical cleaning event, e.g. 2 minutes.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. An oral care appliance for delivery of discrete bursts of liquid to the teeth of a user, comprising:
an appliance body having a firing button;
a liquid reservoir containing approximately 0.2 ml of liquid, sufficient for at least one cleansing event;
a pump/regulator combination for maintaining pressure in the reservoir in the range of 70-120 psi (5-8.5 kg/cm²); and
a control assembly for providing at least two successive bursts of liquid in response to one activation of the firing button, each burst having a time duration of 0.02-2 seconds, and a firing rate between successive liquid bursts in the time range of 0.5-1.5 seconds.

2. The appliance of claim 1, wherein a preferred time duration range of the bursts of liquid is 0.05-0.2 seconds.

3. The appliance of claim 1, wherein the control assembly is manually operated.

4. The appliance of claim 1, wherein the control assembly is automatically operated.

5. (canceled)

6. The appliance of claim 1, wherein the appliance body includes an outlet member 14 and a nozzle assembly 16 at the end thereof through which the bursts of liquid are delivered.

7. The appliance of claim 1, wherein the nozzle assembly includes a plurality of nozzles.

8. The appliance of claim 6, including a drive train assembly within the appliance body for moving the outlet member in a reciprocal manner and a set of bristles at a distal end of the outlet member.

9. The appliance of claim 8, wherein the nozzle assembly includes a plurality of separate nozzles.
